(19) United States
(12) Patent Application Publication
(10) Pub. No.: US 2026/0103633 A1
(43) Pub. Date: Apr. 16, 2026

(54) COOLANT COMPOSITION FOR VEHICLE WITH EXCELLENT COLOR STABILITY AND CORROSION RESISTANCE

(71) Applicants: Hyundai Motor Company, Seoul (KR); Kia Corporation, Seoul (KR); Institute for Research & Industry Cooperation Pusan National University, Busan (KR)

(72) Inventors: Ga Eun LEE, Hwaseong-Si (KR); Jong Seung PARK, Busan (KR)

(21) Appl. No.: 19/279,591

(22) Filed: Jul. 24, 2025

(30) Foreign Application Priority Data
Oct. 11, 2024 (KR) 10-2024-0138615

(51) Int. Cl. C09K 5/10

(52) U.S. Cl. CPC C09K 5/10

(57) ABSTRACT

Disclosed is a coolant composition for a vehicle with excellent color stability and corrosion resistance. A coolant composition for a vehicle may include a dye comprising: a blue dye, and at least one additive selected from the group consisting of a nitrite, a halogen compound, and combinations thereof.

### CROSS-REFERENCE TO RELATED APPLICATION

This application claims priority to Korean Patent Application No. 10-2024-0138615, filed on Oct. 11, 2024, the entire contents of which are incorporated herein by reference.

### TECHNICAL FIELD

The present disclosure relates to a coolant composition for a vehicle with excellent color stability and corrosion resistance.

### BACKGROUND

Vehicle coolants usually have specific colors to provide product identification, prevent drinking thereof, and encourage the use of original equipment manufacturer (OEM) products of specific colors, in addition to inherent cooling performance thereof. Coolants having various colors, including red, green, blue, etc., are manufactured and sold.

Commercially available colored coolants frequently experience decreased color intensity due to discoloration or decoloration (e.g., when operated/stored at high temperatures for long periods of time).

Aluminum has a high strength-to-weight ratio and is thus widely used in vehicle cooling systems. The piping of vehicle cooling systems comprises various alloy materials such as aluminum, etc., and potassium fluoroaluminate flux is typically applied for brazing these parts. When aluminum is exposed to coolant components (such as water, ethylene glycol, etc.) at a high temperature (e.g., for a long period of time) and the components present in the flux leak, aluminum oxide, aluminum hydrate, and the like may be formed.

A dye for use in coolants may comprise an aromatic compound with an extended x-electron conjugation structure. When such a dye is exposed to coolant components (e.g., at a high temperature for a long period of time), decoloration or discoloration may occur due to a change in the structure thereof.

A blue dye has high absorption at a short wavelength, which is a high-energy range, and therefore has low chemical structural stability. It is very difficult to maintain the color stability of the blue coolant for a long time, so there is a great need for technological development thereof.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a coolant composition for vehicle. A coolant composition for a vehicle may comprise: a dye comprising a blue dye; and at least one additive selected from the group consisting of a nitrite, a halogen compound, and combinations thereof.

### BRIEF DESCRIPTION OF THE DRAWING

FIG. 1 shows a device for measuring solution resistance in Example according to the present disclosure.

FIG. 2 shows an example coolant composition.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. The phrase “one or more of” is synonymous with “at least one of” in this application.

A singular expression used herein may include the meaning of the plural unless otherwise stated in the context, which also applies to the singular expression described in the claims.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

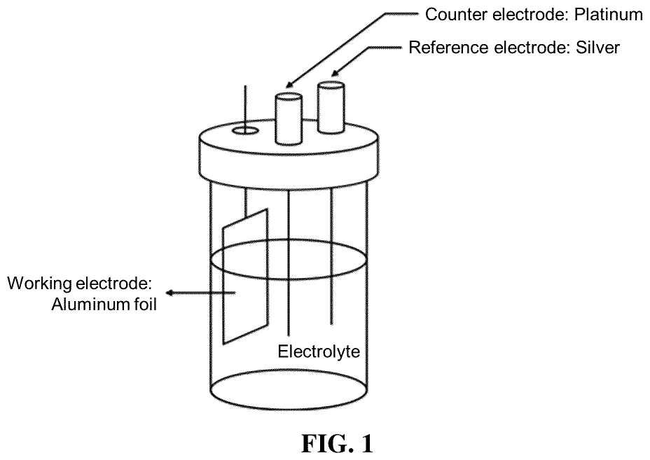

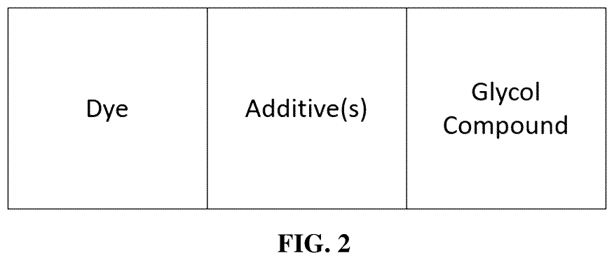

FIG. 1 shows a device for measuring solution resistance in Example according to the present disclosure, and FIG. 2 shows an example coolant composition. The coolant composition may comprise a dye and at least one additive as further described herein. The coolant composition may further comprise a glycol compound as further described herein.

The present disclosure relates to a coolant composition, for a vehicle, capable of maintaining high stability against corrosive components leaking from aluminum alloys and fluxes used in piping of a vehicle cooling system, for example.

The coolant composition may include a glycol compound, a dye, and an additive (e.g., at least one additive). The coolant may be aqueous (e.g., the coolant composition may also include water). The additive may include at least one selected from the group consisting of a nitrite, a halogen compound, and combinations thereof.

The glycol compound may serve to prevent an engine of a vehicle using the coolant from overheating and/or freezing. The glycol compound may include at least one selected from the group consisting of ethylene glycol, propylene glycol, and combinations thereof.

The mass ratio of the glycol compound to water may be 1:0.1 to 1:10. If the mass ratio of the glycol compound falls within the above numerical range, the cooling effect may be achieved while reducing toxicity of the coolant composition for a vehicle.

The dye may be a blue dye, and may include a hydrophilic group including at least one selected from the group consisting of OH, COOH, SO₃H, SO₃Na, and combinations thereof.

In an example, the dye may include a compound represented by Chemical Formula 1 below.

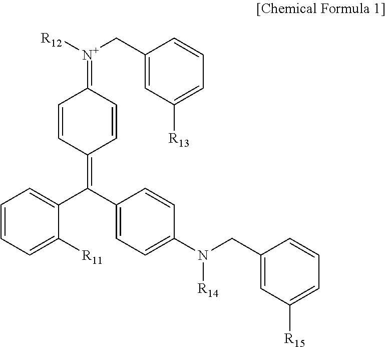

In Chemical Formula 1, each of R₁₁, R₁₃, and R₁₅ may include OH, COOH, SO₃H, or SO₃Na, and each of R₁₂ and R₁₄ may include H or a C1-C10 alkyl group.

Specifically, the dye may include a compound represented by Chemical Formula 1-1 below.

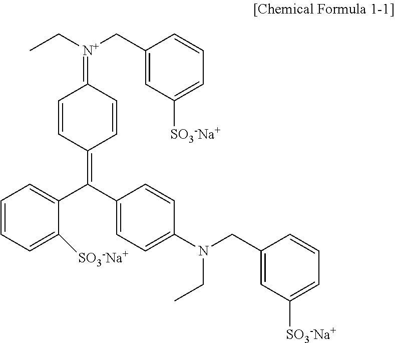

In an example, the dye may include a compound represented by Chemical Formula 2 below.

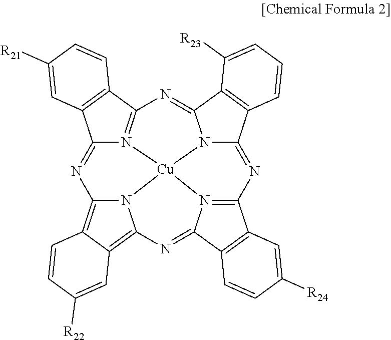

In Chemical Formula 2, each of R₂₁, R₂₂, and Ras may include OH, COOH, SO₃H, or SO₃Na, and R₂ may be represented by Chemical Formula 2-1 below.

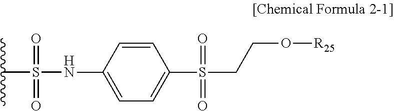

In Chemical Formula 2-1, Ras may include OH, COOH, SO₃H, or SO₃Na.

Specifically, the dye may include a compound represented by Chemical Formula 2-2 below.

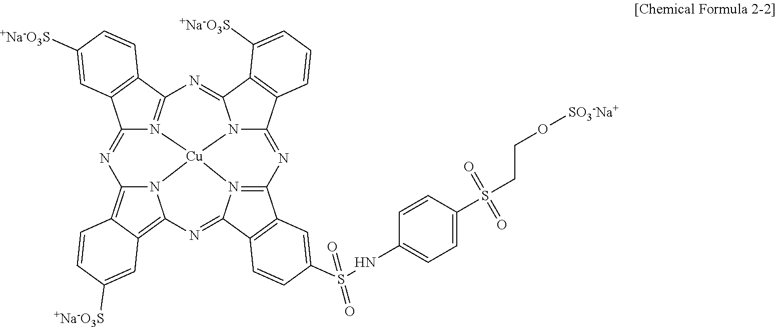

In an example, the dye may include a compound represented by Chemical Formula 3 below.

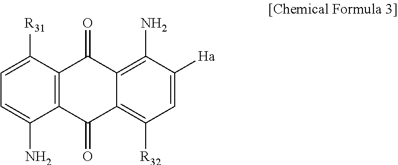

In Chemical Formula 3, each of R₃₁ and R₃₂ may include OH, COOH, SO₃H, or SO₃Na, and Ha may include F, Cl, Br, or I.

Specifically, the dye may include a compound represented by Chemical Formula 3-1 below.

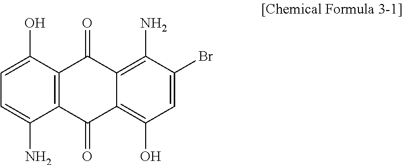 [SMILES: Nc1ccc(O)c2c1C(=O)c1c(O)cc(Br)c(N)c1C2=O]

The dye of any example herein may contain an ethylene glycol group. The dye may contain a hydrophilic group such as OH, COOH, SO₃H, SO₃Na, etc., and thus has low electronic conductivity and excellent stability. However, the dye may have somewhat low solubility in a glycol compound and water due to the hydrophilic group. To complement this, an ethylene glycol group may be added to the dye, in addition to the hydrophilic group. The ethylene glycol group has high electronic conductivity but is highly soluble in a glycol compound and water. Accordingly, by adding both a hydrophilic group and an ethylene glycol group to the dye, the solubility may be increased and low electronic conductivity may be maintained.

The dye containing the hydrophilic group and the ethylene glycol group may include a compound represented by Chemical Formula 4 below.

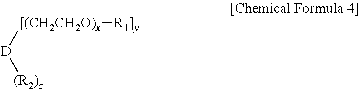

In Chemical Formula 4, D is a chromophore of the dye (e.g., a blue chromophore of a blue dye as/of the dye). D may include, for example, triphenylmethane, phthalocyanine, and/or anthraquinone.

R₁ may include H or OH, R₂ may include OH, COOH, SO₃H, or SO₃Na, x may be a number from 3 to 20, y may be a number from 2 to 4, and z may be a number from 1 to 3.

The concentration of the dye (in the coolant composition) may be 1 μM to 50 μM. If the concentration of the dye falls in the above numerical range, color development of the coolant composition for a vehicle may be sufficiently achieved while reducing environmental pollution and preventing the formation of sediment or residue.

Without limiting to theory, the nitrite may serve to prevent corrosion of metal parts and reduce rust in the cooling system. Also, or alternatively, without limiting to theory, the nitrite may serve to adjust the pH of the coolant composition for a vehicle and form an oxide film on the metal surface to prevent corrosion.

The nitrite may include at least one selected from the group consisting of potassium nitrite (KNO₂), sodium nitrite (NaNO₂), tetrabutylammonium nitrite ((CH₃CH₂CH₂CH₂)₄N(NO₂)), and combinations thereof.

The amount of the nitrite is not particularly limited and may be, for example, 0.1 wt % to 10 wt % based on the total weight of the coolant composition. If the amount of the nitrite falls in the above numerical range, a corrosion prevention effect may be achieved without damage to inherent function of the coolant composition.

Without limiting to theory, the halogen compound may serve to increase the stability of the dye.

The halogen compound may include an iodine salt. The iodine salt may include at least one selected from the group consisting of potassium iodide (KI), sodium iodide (NaI), tetrabutylammonium iodide ((CH₃CH₂CH₂CH₂)₄NI), and combinations thereof.

The amount of the halogen compound is not particularly limited and may be, for example, 0.1 wt % to 10 wt % based on the total weight of the coolant composition. If the amount of the halogen compound falls in the above numerical range, the stability of the dye may be increased without damage to inherent function of the coolant composition for a vehicle.

The coolant composition for a vehicle may further include a lubricant, an anti-scale agent, an anti-foaming agent, etc.

The coolant composition may include 75 to 95 wt % of the sum of glycol compound and water, 0.1 to 5 wt % of the dye, 0.1 to 10 wt % of the nitrite, and 0.1 to 10 wt % of the halogen compound. However, the amounts of the components of the coolant composition for a vehicle are not limited to the above numerical ranges, and may be appropriately adjusted depending on the desired function, purpose, and effect.

A better understanding of the present disclosure may be obtained through the following examples. These examples are merely set forth to illustrate the present disclosure, and are not to be construed as limiting the scope of the present disclosure.

### Examples 1 to 9 and Comparative Examples 1 to 3

Respective coolant compositions for vehicles were prepared by adding a dye, a nitrite, and/or a halogen compound to an aqueous ethylene glycol solution in which ethylene glycol was dissolved in water, as shown in Table 1 below. The concentration of the dye in each compound was about 25 μM, and the amounts of nitrite and halogen compound added to each sample were also about 25 μM if present (as indicated). In samples to which the nitrite and the halogen compound were not added, the amount of the aqueous glycol solution was increased by corresponding amounts.

TABLE 1

| | | | Halogen |
|---|---|---|---|
| Classification | Dye | Nitrite | compound |
| Example 1 | Chemical Formula 2-1 | ∘ | ∘ |
| Example 2 | | x | ∘ |
| Example 3 | | ∘ | x |
| Example 4 | Chemical Formula 3-2 | ∘ | x |
| Example 5 | | x | ∘ |
| Example 6 | Chemical Formula 4-1 | ∘ | x |
| Example 7 | | x | ∘ |
| Example 8 | Chemical Formula 2-1 and | ∘ | x |
| | Chemical Formula 4-1** | | |
| Example 9 | Chemical Formula 2-1 and | ∘ | x |
| | Chemical Formula 3-2*** | | |
| Comparative | Chemical Formula 2-1 | x | x |
| Example 1 | | | |
| Comparative | Chemical Formula 3-2 | x | x |
| Example 2 | | | |
| Comparative | Chemical Formula 4-1 | x | x |
| Example 3 | | | |

**Use of mixture of compound of Chemical Formula 2-1 and compound of Chemical Formula 4-1 in a mass ratio of 1:1
***Use of mixture of compound of Chemical Formula 2-1 and compound of Chemical Formula 3-2 in a mass ratio of 1:1

The color, decoloration or discoloration stability, pH change, and solution resistance of each sample from Table 1 were measured as follows. The results thereof are shown in Table 2 below.
Color: The dye was dissolved in an aqueous ethylene glycol solution followed by measurement by UV-Visible spectroscopy. If the maximum absorption wavelength fell in the range of 5,701 nm to 700 nm, it is marked as o, otherwise it is marked as x.
Decoloration or discoloration (e.g., lack of color stability): The example and comparative example coolant compositions for a vehicle were treated at 60° C. for 48 hours, after adding 0.5 wt % of each of aluminum powder and flux powder, followed by measurement by UV-Visible spectroscopy. If the difference in absorbance at the maximum absorption wavelength falls within 0-0.19 (no to low change, high color stability), it is marked as ⊚, if it falls in the range of 0.2 to 0.49 (low to moderate change, moderate color stability), it is marked as o, if it falls in the range of 0.5 to 0.99, it is marked as Δ (moderate to high change-low color stability), and if it is 1.0 (complete decoloration), it is marked as x.
Change in pH: The example and comparative example coolant composition for a vehicle were treated at 60° C. for 48 hours after adding 0.5 wt % of each of aluminum powder and flux powder, followed by measurement of a change in pH. If the change in pH falls within 0-0.2 (e.g., no to low change), it is marked as ⊚, if it falls in the range of 0.2 to 0.5 (e.g. low to moderate change), it is marked as ∘, if it falls in the range of 0.5 to 0.9 (moderate to high change), it is marked as Δ, and if it is 0.9 or higher (high change), it is marked as x.
Solution resistance: The example and comparative coolant compositions for a vehicle were treated at 60° C. for 48 hours after adding 0.5 wt % of each of aluminum powder and flux powder, followed by measurement by electrochemical impedance spectroscopy. A three-electrode system including aluminum (working electrode), platinum (counter electrode), and silver (reference electrode) was used, as shown in FIG. 1. If the solution resistance calculated from the measured Z′ value is 50Ω or higher (high solution resistance), it is marked as ∘, and if it is less than 50Ω (low solution resistance), it is marked as x.

TABLE 2

| | | Decoloration or | | |
|---|---|---|---|---|
| | | discoloration | Change | Solution |
| Classification | Color | stability | in pH | resistance |
| Example 1 | ◯ | ⊚ | ⊚ | ◯ |
| Example 2 | ◯ | ⊚ | X | ◯ |
| Example 3 | ◯ | ⊚ | ◯ | ◯ |
| Example 4 | ◯ | ⊚ | ◯ | ◯ |
| Example 5 | ◯ | ⊚ | ◯ | ◯ |
| Example 6 | ◯ | ⊚ | ◯ | ◯ |
| Example 7 | ◯ | ⊚ | Δ | ◯ |
| Example 8 | ◯ | ⊚ | ◯ | ◯ |
| Example 9 | Δ | ◯ | ◯ | ◯ |
| Comparative | ◯ | Δ | X | X |
| Example 1 | | | | |
| Comparative | Δ | X | ⊚ | ◯ |
| Example 2 | | | | |
| Comparative | ◯ | X | ◯ | ◯ |
| Example 3 | | | | |

Referring to Examples 1 to 3 and Comparative Example 1, Example 1, in which the corrosion inhibitor and the halogen compound were added to the dye according to the present disclosure, exhibited the best effects in view of color, decoloration or discoloration stability, pH change, and solution resistance. Comparative Example 1, without the nitrite and the halogen compound, had a great change in pH and low solution resistance, resulting in poor stability against corrosive components.

Referring to Examples 4 and 5 and Comparative Example 2, Examples 4 and 5 including the dye according to the present disclosure and the nitrite or the halogen compound exhibited vastly superior decoloration or discoloration stability compared to Comparative Example 2.

Referring to Examples 6 and 7 and Comparative Example 3, similarly to the above, Examples 6 and 7 including the dye according to the present disclosure and the nitrite or the halogen compound exhibited superior decoloration or discoloration stability compared to Comparative Example 3.

Referring to Examples 8 and 9, in which the dye components according to the present disclosure were used in combination, superior decoloration or discoloration stability and stability against corrosive components were exhibited.

An object of the present disclosure is to provide a coolant composition for a vehicle capable of maintaining the color thereof even when used at a high temperature for a long period of time.

Another object of the present disclosure is to provide a coolant composition with excellent stability against decoloration or discoloration.

Still another object of the present disclosure is to provide a coolant composition for a vehicle including a blue dye having high compatibility and solubility in water and a glycol compound.

The objects of the present disclosure are not limited to the foregoing. The objects of the present disclosure will be able to be clearly understood through the following description and to be realized by the means described in the claims and combinations thereof.

An embodiment of the present disclosure provides a coolant composition for a vehicle, including a dye and at least one additive selected from the group consisting of a nitrite, a halogen compound, and combinations thereof.

The coolant composition may further include a glycol compound.

The dye may include a hydrophilic group including at least one selected from the group consisting of OH, COOH, SO3H, SO3Na, and combinations thereof, and optionally, the dye may further include an ethylene glycol group.

The glycol compound may include at least one selected from the group consisting of ethylene glycol, propylene glycol, and combinations thereof.

The dye may include a compound represented by Chemical Formula 1 below.

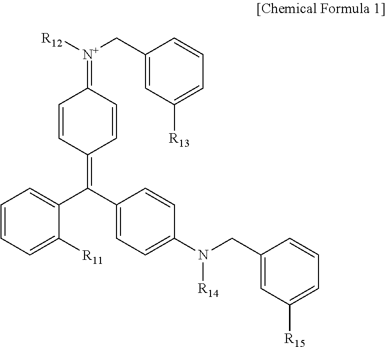

In Chemical Formula 1, each of R₁₁, R₁₃, and R₁₅ may include OH, COOH, SO₃H, or SO₃Na, and each of R₁₂ and R₁₄ may include H or a C1-C10 alkyl group.

The dye may include a compound represented by Chemical Formula 2 below.

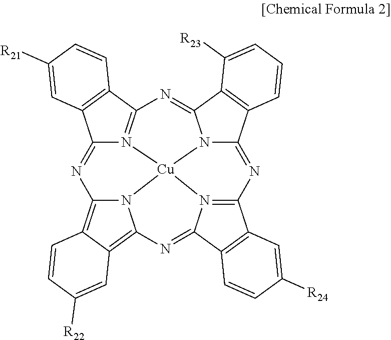

In Chemical Formula 2, each of R₂₁, R₂₂, and R₂₃ may include OH, COOH, SO₃H, or SO₃Na, and R₂₄ may be represented by Chemical Formula 2-1 below.

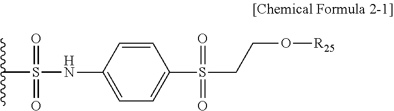

In Chemical Formula 2-1, R₂₅ may include OH, COOH, SO₃H, or SO₃Na.

The dye may include a compound represented by Chemical Formula 3 below.

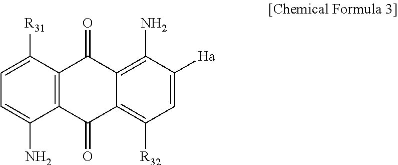

In Chemical Formula 3, each of R₃₁ and R₃₂ may include OH, COOH, SO₃H, or SO₃Na, and Ha may include F, Cl, Br, or I.

The dye may be a blue dye.

The concentration of the dye may be 1 μM to 50 μM.

The nitrite may include at least one selected from the group consisting of potassium nitrite (KNO₂), sodium nitrite (NaNO₂), tetrabutylammonium nitrite ((CH₃CH₂CH₂CH₂)₄N(NO₂)), and combinations thereof.

The amount of the nitrite may be 0.1 wt % to 10 wt %.

The halogen compound may include an iodine salt.

The iodine salt may include at least one selected from the group consisting of potassium iodide (KI), sodium iodide (NaI), tetrabutylammonium iodide ((CH₃CH₂CH₂CH₂)₄NI), and combinations thereof.

The amount of the halogen compound may be 0.1 wt % to 10 wt %.

Disclosed is a coolant composition for a vehicle capable of maintaining the color thereof even when used at a high temperature for a long period of time.

The coolant composition may have excellent stability against decoloration or discoloration. The coolant composition for a vehicle may include: a blue dye having high compatibility and/or solubility in water, and a glycol compound.

The effects of the present disclosure are not limited to those explicitly described herein. It should be understood that the effects of the present disclosure include all effects that can be inferred by one skilled in the art from the present disclosure.

Whereas the examples of the present disclosure have been described in detail above, the scope of the present disclosure is not limited to the aforementioned examples, and various modifications, substitutions and variations made by those skilled in the art using the basic concept of the present disclosure defined in the following claims are also within the scope of the present disclosure.

What is claimed is:

1. A coolant composition for a vehicle, the coolant composition comprising:
a dye comprising a blue dye; and
at least one additive selected from the group consisting of a nitrite, a halogen compound, and combinations thereof.

2. The coolant composition of claim 1, further comprising a glycol compound.

3. The coolant composition of claim 1, wherein the dye comprises at least one hydrophilic group selected from the group consisting of OH, COOH, SO₃H, SO₃Na, and combinations thereof.

4. The coolant composition of claim 1, wherein the dye comprises a compound represented by Chemical Formula 1 below: 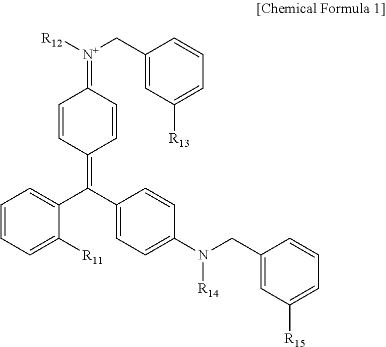
wherein:
each of R₁₁, R₁₃, and R₁₅ comprises OH, COOH, SO₃H, or SO₃Na, and
each of R₁₂ and R₁₄ comprises H or a C1-C10 alkyl group.

5. The coolant composition of claim 1, wherein the dye comprises a compound represented by Chemical Formula 2 below: 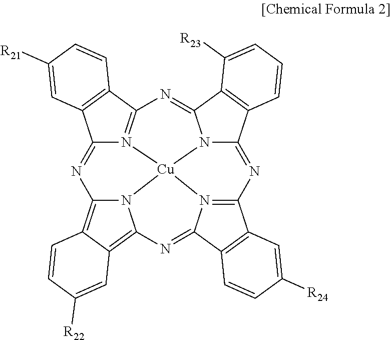
wherein:
each of R₂₁, R₂₂, and R₂₃ comprises OH, COOH, SO₃H, or SO₃Na, and
R₂₄ is represented by Chemical Formula 2-1 below: 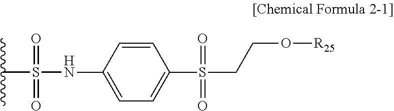
wherein, R₂₅ comprises OH, COOH, SO₃H, or SO₃Na.

6. The coolant composition of claim 1, wherein the dye comprises a compound represented by Chemical Formula 3 below: 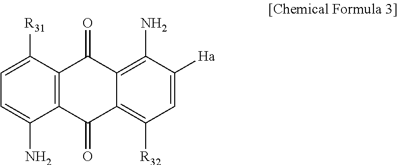
wherein:
each of R₃₁ and R₃₂ comprises at least one of OH, COOH, SO₃H, or SO₃Na, and
Ha comprises at least one of F, Cl, Br, or I.

7. The coolant composition of claim 1, wherein a concentration of the dye is 1 μM to 50 μM.

8. The coolant composition of claim 1, wherein the nitrite comprises at least one selected from the group consisting of potassium nitrite (KNO₂), sodium nitrite (NaNO₂), tetrabutylammonium nitrite ((CH₃CH₂CH₂CH₂)₄N(NO₂)), and combinations thereof.

9. The coolant composition of claim 1, wherein an amount of the nitrite in the coolant composition is 0.1 wt % to 10 wt %.

10. The coolant composition of claim 1, wherein the halogen compound comprises an iodine salt.

11. The coolant composition of claim 10, wherein the iodine salt comprises at least one selected from the group consisting of potassium iodide (KI), sodium iodide (NaI), tetrabutylammonium iodide ((CH₃CH₂CH₂CH₂)₄NI), and combinations thereof.

12. The coolant composition of claim 1, wherein an amount of the halogen compound in the coolant composition is from 0.1 wt % to 10 wt %.

13. The coolant composition of claim 1, comprising both the nitrite and the halogen compound.
